(19) United States
(12) Patent Application Publication
(10) Pub. No.: US 2026/0025066 A1
(43) Pub. Date: Jan. 22, 2026

(54) SYSTEMS AND METHODS FOR EFFICENT OPERATION OF CRITICAL AND DISCONTINUOUS CONDUCTION MODE TOTEM-POLE PFC CIRCUITS

(71) Applicant: Navitas Semiconductor Limited, Dublin (IE)

(72) Inventors: Weijing DU, Torrance, CA (US); Xiucheng HUANG, Torrance, CA (US)

(73) Assignee: Navitas Semiconductor Limited, Dublin (IE)

(21) Appl. No.: 19/270,039

(22) Filed: Jul. 15, 2025

(30) Foreign Application Priority Data
Jul. 18, 2024 (CN) 202410968616.1

(51) Int. Cl. H02M 1/42; H02M 1/00; H02M 1/32

(52) U.S. Cl. CPC H02M 1/4208; H02M 1/0009; H02M 1/32

(57) ABSTRACT

A PFC circuit is disclosed. The circuit includes a first switch having a first power switch, a first current sense circuit and a first overcurrent protection circuit, a second switch having a second power switch, a second current sense circuit and a second overcurrent protection circuit, the first switch coupled to the second switch at a switch node, an inductor coupled between the switch node and an AC input terminal, and a controller arranged to transmit control signals to the first and second switches, where the first current sense circuit is arranged to transmit a first signal including at least one of a magnitude and a polarity of a first current through the first power switch, and the first overcurrent protection circuit is arranged to receive the first signal and transition the first power switch to a first off-state in response to the first signal exceeding a first predetermined threshold.

### CROSS REFERENCE TO RELATED APPLICATIONS

This application claims priority to Chinese provisional patent application no. 202410968616.1, for “CRM TOTEM POLE PFC CONTROL STRATEGY” filed on Jul. 18, 2024, which is hereby incorporated by reference in entirety for all purposes.

### FIELD

The described embodiments relate generally to power converters, and more particularly, the present embodiments relate to systems and methods for efficient operation of critical and discontinuous conduction mode totem-pole power factor correction (PFC) circuits.

### BACKGROUND

Electronic devices such as computers, servers and televisions, among others, employ one or more electrical power conversion circuits to convert one form of electrical energy to another. Some electrical power conversion circuits convert a high (or low) DC voltage to a lower (or higher) DC voltage using a circuit topology called DC-DC converter. As many electronic devices are sensitive to size and efficiency of the power conversion circuit, new power converters can provide relatively higher efficiency and lower size for the new electronic devices. In some applications, a totem-pole bridgeless power factor correction (PFC) circuits can be used. However, in current approaches cycle-by-cycle overcurrent protection (OCP) and synchronous rectifier mode (SR) detection and control can be complex and costly. Accordingly, there is a need in the art for improved cycle-by-cycle overcurrent protection (OCP) and synchronize rectifier (SR) mode detection and control in totem-pole bridgeless PFC circuits.

### SUMMARY

In some embodiments, a power factor correction (PFC) circuit is disclosed. The circuit includes a first switch having a first power switch, a first current sense circuit and a first overcurrent protection circuit; a second switch having a second power switch, a second current sense circuit and a second overcurrent protection circuit, the first switch coupled to the second switch at a switch node; an inductor coupled between the switch node and an AC input terminal; and a controller arranged to transmit control signals to the first and second switches; where: the first current sense circuit is arranged to transmit a first signal including at least one of a magnitude and a polarity of a first current through the first power switch; and the first overcurrent protection circuit is arranged to receive the first signal and transition the first power switch to a first off-state in response to the first signal exceeding a first predetermined threshold.

In some embodiments, the second current sense circuit is arranged to transmit a second signal including at least one of a magnitude and a polarity of a second current through the second power switch.

In some embodiments, the second overcurrent protection circuit is arranged to receive the second signal and transition the second power switch to a second off-state in response to the second signal exceeding a second predetermined threshold.

In some embodiments, the first switch further includes a first driver circuit arranged to transmit first control signals to the first power switch based at least in part on the first signal and the control signals.

In some embodiments, the second switch further includes a second driver circuit arranged to transmit second control signals to the second power switch based at least in part on the second signal and the control signals.

In some embodiments, a first switch further includes a first synchronous rectification (SR) mode detection circuit that is arranged to generate a first SR signal in response to receiving the first signal.

In some embodiments, the first driver circuit is further arranged to transmit the first control signals to the first power switch based at least in part on the first SR signal.

In some embodiments, the second switch further includes a second synchronous rectification (SR) mode detection circuit that is arranged to generate a second SR signal in response to receiving the second signal.

In some embodiments, a method of operating a power factor correction (PFC) circuit is disclosed. The method includes providing a first switch having a first power switch, a first current sense circuit and a first overcurrent protection circuit; providing a second switch having a second power switch, a second current sense circuit and a second overcurrent protection circuit, the first switch coupled to the second switch at a switch node; providing an inductor coupled between the switch node and an AC input terminal; and providing a controller arranged to transmit control signals to the first and second switches; transmitting a first signal, by the first current sense circuit, including at least one of a magnitude and a polarity of a first current through the first power switch; and receiving the first signal, by the first overcurrent protection circuit; and transitioning the first power switch to a first off-state in response to the first signal exceeding a first predetermined threshold.

In some embodiments, a circuit is disclosed. The circuit includes a first switch having a first power switch, a first current sense circuit and a first overcurrent protection circuit; a second switch having a second power switch, a second current sense circuit and a second overcurrent protection circuit, the first switch coupled to the second switch at a switch node; an inductor coupled between the switch node and an AC input terminal; and where the first current sense circuit is arranged to transmit a first signal including at least one of a magnitude and a polarity of a first current through the first power switch; and where the first overcurrent protection circuit is arranged to receive the first signal and transition the first power switch to a first off-state in response to the first signal exceeding a first predetermined threshold.

### BRIEF DESCRIPTION OF THE DRAWINGS

FIG. 1 illustrates a simplified schematic of a totem-pole power factor conversion (PFC) circuit with current sensing and overcurrent protection circuit disposed relatively close to the power switches, according to some embodiments;

FIG. 2 illustrates a simplified schematic of a totem-pole power factor conversion (PFC) circuit with current sensing and overcurrent protection with integrated high-side and low-side switches, according to some embodiments;

FIG. 3 illustrates graphs of operation waveforms at various nodes in the PFC circuit of FIG. 1 where the high-side switch operates as the main switch, according to some embodiments; and

FIG. 4 illustrates graphs of operation waveforms at various nodes in the PFC circuit of FIG. 1 where the high-side switch operates as synchronous rectifier (SR) switch, according to some embodiments.

### DETAILED DESCRIPTION

Circuits, devices and related techniques disclosed herein relate generally to electronic circuits. More specifically, circuits, devices and related techniques disclosed herein relate to systems and methods for efficient operation of critical and discontinuous conduction mode totem-pole power factor correction (PFC) circuits. Circuits and techniques disclosed herein enable current sensing and overcurrent protection in critical conduction mode (CRM) and discontinuous conduction mode (DCM) totem-pole PFC circuits. In some embodiments, a bidirectional current sensing circuit may be coupled to each of the control switch and the synchronous switch of a totem-pole PFC circuit. The bidirectional current sensing circuit can be arranged to generate a signal based on at least one of direction and/or a magnitude of a current flowing through the switches. In various embodiments, the generated signal can be used to determine when an overcurrent condition has occurred in the switch and in response, turn off the switch. In some embodiments, the generated signal can be used to determine whether a switch is operating in a control mode or in a synchronous rectification (SR) mode. When the switch is operating in SR mode, an SR determination circuit can turn off the switch if the current flowing through the switch exceeds a predetermined threshold.

In various embodiments, an integrated circuit (IC) can include a power switch, a bidirectional current sensing circuit, an SR determination circuit, a overcurrent protection (OCP) circuit and a driver circuit. The IC can be used in the high-side and/or in the low-side section of the totem-pole PFC circuit, such as those described in U.S. patent application Ser. No. 17/667,335, “Systems and Methods for Automatic determination of State of Switches in Power Converters” filed Feb. 8, 2022, the contents of which are hereby incorporated by reference. In some embodiments, the predetermined threshold can be set inside the IC. In various embodiments, the predetermined threshold can be set externally using an impedance element such as, but not limited to, a resistor. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

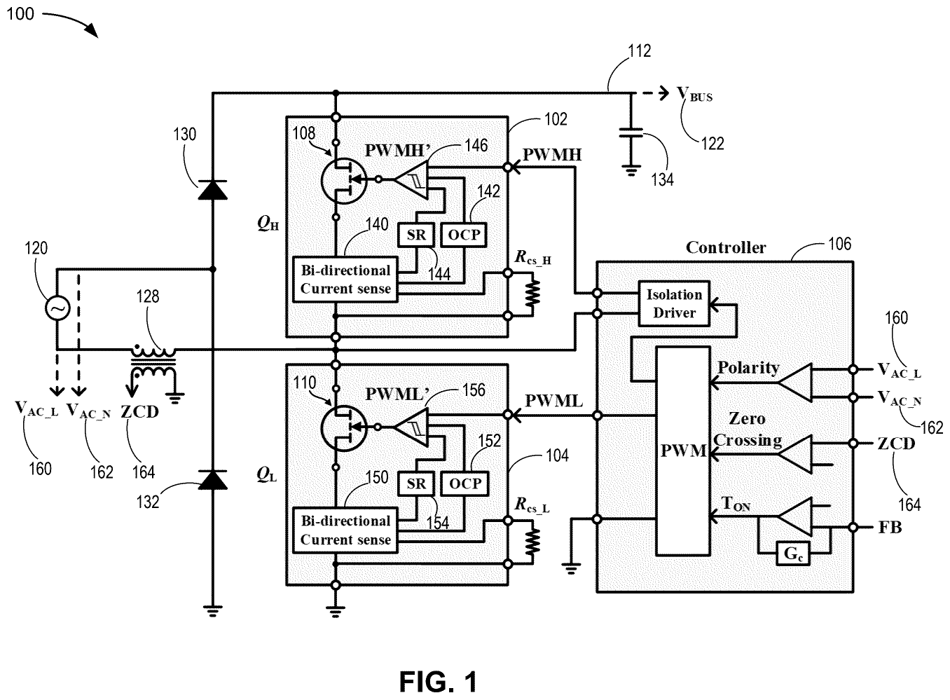

FIG. 1 illustrates a simplified schematic of a totem-pole power factor conversion (PFC) circuit with current sensing and overcurrent protection circuits disposed relatively close to the power switches, according to some embodiments. As shown in FIG. 1, a PFC circuit 100 may receive an AC power input from an AC source Vac 120 and generate an output voltage (VBUS) 122 at an output terminal 112. The PFC circuit 100 may include a controller 106, input in inductor 128, a high-side switch 102, a low-side switch 104, a diode 130 and a diode 132, and output capacitor 134. Diodes 130 and 132 may be implemented using any current rectifying structure, such as, but not limited to, pn junction diode or as a diode connected transistor, as understood by those of skill in the art. In some embodiments, diodes 130 and 132 may be implemented with switches which are actively controlled by controller 106. Output capacitor 134 may be implemented using any capacitor structure, such as, but not limited to, two metal conductor plates separated by a dielectric or as one or more transistors having their drain and source terminals electrically shorted, where the drain/source terminal functions as a first plate of the capacitor and the gate of transistor functions as a second plate of the capacitor.

The high-side switch 102 may include a high-side power switch 108, a bidirectional current sense circuit 140 coupled to the high-side power switch 108, an overcurrent protection (OCP) circuit 142, a synchronous rectifier circuit 144 and comparator circuit 146. The low-side switch 104 may include a low-side power switch 110, a bidirectional current sense circuit 150 coupled to the high-side power switch 110, an overcurrent protection (OCP) circuit 152, a synchronous rectifier mode circuit 154 and comparator circuit 156. Each of the comparator circuits 146 or 156 can include hysteresis. In some embodiments, each of the comparator circuits 146 or 156 can include a driver circuit arranged to drive gate terminal of the high-side and/or low-side power switches.

The controller 106 may be arranged to receive to receive a voltage FB that is generated based on the output voltage 122, a line voltage 160, a neutral voltage 162 and a zero current detection (ZCD) signal 164. Based on the voltage FB, line voltage 160, neutral voltage 162 and ZCD signal 164, the controller 106 can be arranged to generate control signals for each of high-side switch 102 and the low-side switch 104. For example, controller 106 may be configured to generate pulse width modulation (PWM) signals which can control the conductivity states of the high-side power switch 108 and the low-side power switch 110.

Each of the high-side switch and the low-side switch can be arranged to respond to the control signals received from controller 106 by becoming either conductive or nonconductive. In some embodiments, each of the high-side switch and the low side switch may be arranged to become either conductive or nonconductive in response to the control signals and in response to an electrical condition of the high-side switch and/or the low-side switch. For example, either or both of high side switch S1 and low side switch S2 may be configured to receive a control signal from the controller 106 and wait for a particular electrical condition to occur before becoming conductive or nonconductive according to the control signal.

In the illustrated embodiment, the current sensing for the high-side can be performed by the bidirectional current sense circuit 140 disposed inside the high-side switch 102, and the current sensing for the low-side can be performed by the bidirectional current sense circuit 150 disposed inside the low-side switch 104. The sensed high-side signal and the sense low-side signal can be used for cycle-by-cycle overcurrent protection during magnetizing period of the main switch. In some embodiments, the controller 106 can be arranged to receive an auxiliary winding voltage and based on a change in the auxiliary winding voltage can determine whether an overcurrent condition has occurred. In response to this determination, the controller 106 may adjust on-time of the switch or may cause the switch to enter into overcurrent protection by shutting down.

For SR control during the de-magnetizing period, SR current sensing and corresponding turn-off of the power switch can be performed inside the high-side and low-side switches. The controller 106 can be arranged to receive SR turn-off information from the auxiliary voltage change. The controller 106 can wait for a predetermined time period, followed by transmission of a turn-on signal to the main switch in order to start the next switching cycle.

In various embodiments, overcurrent protection and synchronous rectification control can be performed inside the high-side and low-side switches, and an auxiliary winding voltage change can be used to indicate the device operation states, such as when cycle-by-cycle OCP mode is to be entered, or when SR turn-off mode is to be entered. Thus, the controller 106 can be arranged to determine if the system can enter protection mode, or start a new switching cycle.

The bidirectional current sensing circuit 140 can be arranged to generate a signal based on at least one of direction and/or a magnitude of a current flowing through the power switch 108. In some embodiments, the bidirectional current sensing circuit 140 can include a relatively small transistor coupled in parallel with the power switch 108. The signal can be transmitted to OCP circuit 142 and to SR circuit 144. The OCP circuit 142 can compare the signal with a predetermined threshold and transmit an output signal based on the comparison. The SR circuit can use the signal to determine whether an SR mode of operation is to be entered. The output signal of the OCP circuit 142 and an output signal of the SR circuit can be received by the comparator 146. The comparator 146 can also receive a pulse width modulated (PWM) signal. The comparator 146 can be arranged to turn off the power switch 108 when an overcurrent condition has occurred. Further, the comparator 146 can be arranged to turn off the power switch 108 when an SR mode of operation is to be entered. The low-side switch 104 operates similar to the high-side switch 102, with respect to the bidirectional current sense circuit 150, the SR mode circuit 154, OCP circuit 152 and the comparator circuit 156. In some embodiments, the SR circuit 144 can enable the power switch to operate as an ideal diode or have reverse channel conduction when the current through the power switch is negative (flowing from source to drain). In some embodiments, each of the high-side switch 108 and the low-side switch 104 be formed in silicon, GaN or any other suitable semiconductor material. In various embodiments, the bidirectional current sense circuit, the OCP circuit, the SR circuit and the comparator circuits, and the power switch can be formed in a silicon substrate. In some embodiments, the bidirectional current sense circuit, the OCP circuit, the SR circuit and the comparator circuits, and the power switch can be formed in a GaN substrate. In various embodiments, the OCP circuit, the SR circuit and the comparator circuits can be formed in a silicon substrate while the power switch and the bidirectional current sense circuit can be formed in a GaN substrate. In some embodiments, the OCP circuit, the SR circuit and the comparator circuits, and the power switch and the bidirectional current sense circuit can be monolithically integrated onto a single die. In various embodiments, the OCP circuit, the SR circuit and the comparator circuits can be formed in a first die, and the power switch and the bidirectional current sense circuit can be formed on a second die. In some embodiments, the OCP circuit, the SR circuit and the comparator circuits, and the power switch and the bidirectional current sense circuit can be integrated into one electronic package, for example, but not limited to, a quad-flat no-lead (QFN) package, or into a dual-flat no-leads (DFN) package, into a ball grid array (BGA) package. In some embodiments, the OCP circuit, the SR circuit and the comparator circuits, and the power switch and the bidirectional current sense circuit can be individually packaged into an electronic package.

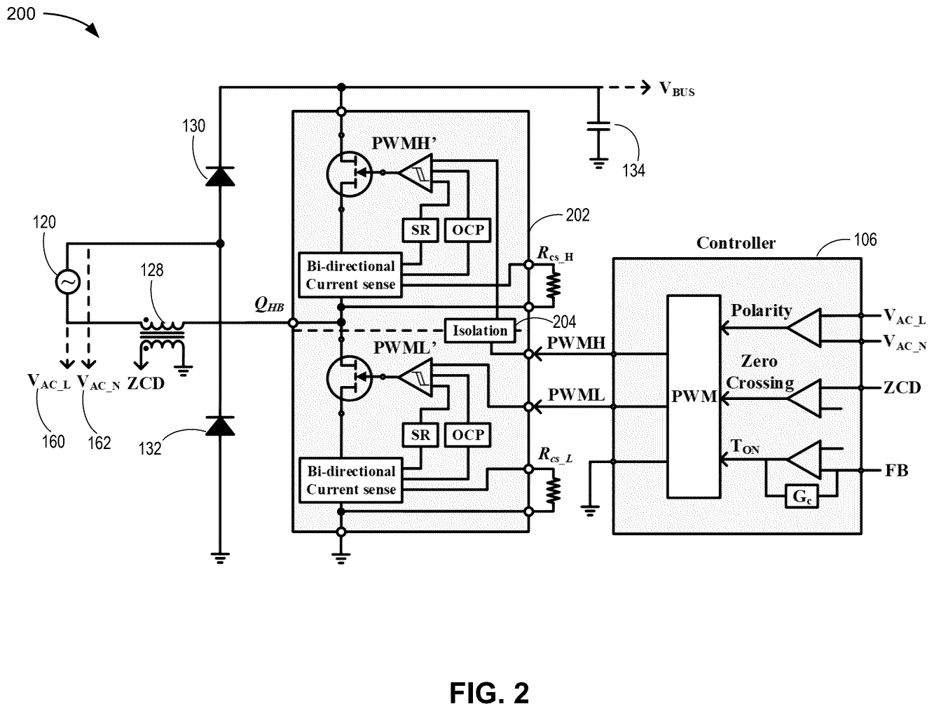

FIG. 2 illustrates a simplified schematic of a totem-pole power factor conversion (PFC) circuit with current sensing and overcurrent protection with integrated high-side and low-side switches, according to some embodiments. FIG. 2 shows a PFC circuit 200 similar to the PFC circuit 100, where the high-side and low-side switches may be integrated into a unitary semiconductor package 202. In some embodiments, the high-side and low-side switches may be integrated into a single semiconductor die. An isolation circuit 204 may be included in the unitary semiconductor package 202 in order to isolate the high-side circuits from the low-side circuits.

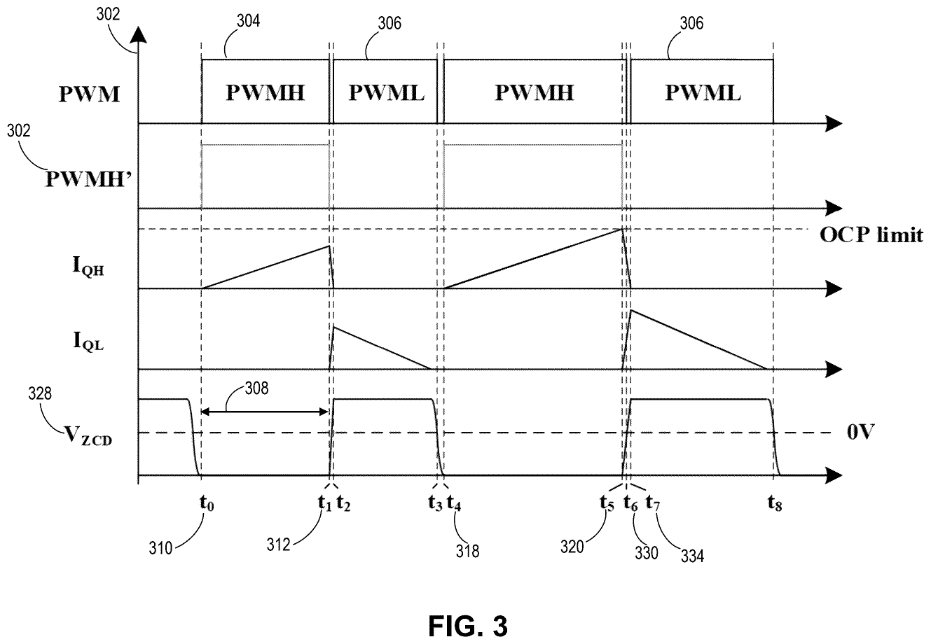

FIG. 3 illustrates graphs of operation waveforms at various nodes in PFC circuit of FIG. 1, according to some embodiments. FIG. 3 shows the waveforms at various nodes in the PFC circuit 100 when switch 102 (Q_{H}) operates as the main switch. The controller 106 can generate an on-time (T_{ON}) based on the feedback voltage FB and can turn on Q_{H} at time 310 (labeled t₀). During time period 308 (i.e., time between t₀-t₁), the inductor 128 may be magnetized and a current through the switch 102 (labeled I_{QH}) can rise. During normal operating conditions, I_{QH} may stay below an overcurrent protection (OCP) threshold. In this way, Q_{H} can be turned off by the controller 106 at time 312 (labeled t₁). Signal 302 (labeled PWMH′) is the signal that is applied to the gate terminal of the power switch 108

During normal operation, the PWMH′ signal may follow signal 304 (labeled PWMH) which is generated by controller 106. Circuits and techniques disclosed herein enable overcurrent protection function to be performed very close to the power switch rather than being performed at the controller. In this way, a response to an overcurrent condition can be performed relatively rapidly without assistance from the controller. Under some abnormal operating conditions, after Q_{H} is turned on at time 318 (labeled t₄), I_{QH} may reach the OCP threshold at time 320 (labeled t₅). In response, OCP circuit 142 can pull down the PWMH′ signal causing turn-off of Q_{H} in a relatively rapid fashion, while PWMH signal is still high. After Q_{H} is turned off at t₅, the inductor 128 may start resonating due to the presence of parasitic junction capacitance of Q_{H} and Q_{I}.

In response, the auxiliary winding voltage 328 (labeled V_{ZCD}) may change from low state to high state. At time 330 (labeled t₆) the V_{ZCD} signal can reach OV where the controller 106 can detect the zero-crossing of the V_{ZCD} signal. When zero-crossing of the V_{ZCD} signal occurs while PWMH signal is high, the controller 106 may interpret this occurrence as an overcurrent condition occurring. Thus, PWMH may be pulled down at t₆. After a predetermined time period has elapsed, the controller 106 can turn signal 306 (labeled PWML) to high state indicating switch 104 to be operating in synchronous rectifier (SR) mode of operation at time 334 (labeled t₇). Embodiments of the disclosure enable relatively rapid turn-off of the power switch when an overcurrent condition occurs. In some embodiments, the controller can get notified of the occurrence of the overcurrent condition by a change in voltage of the auxiliary winding inductor.

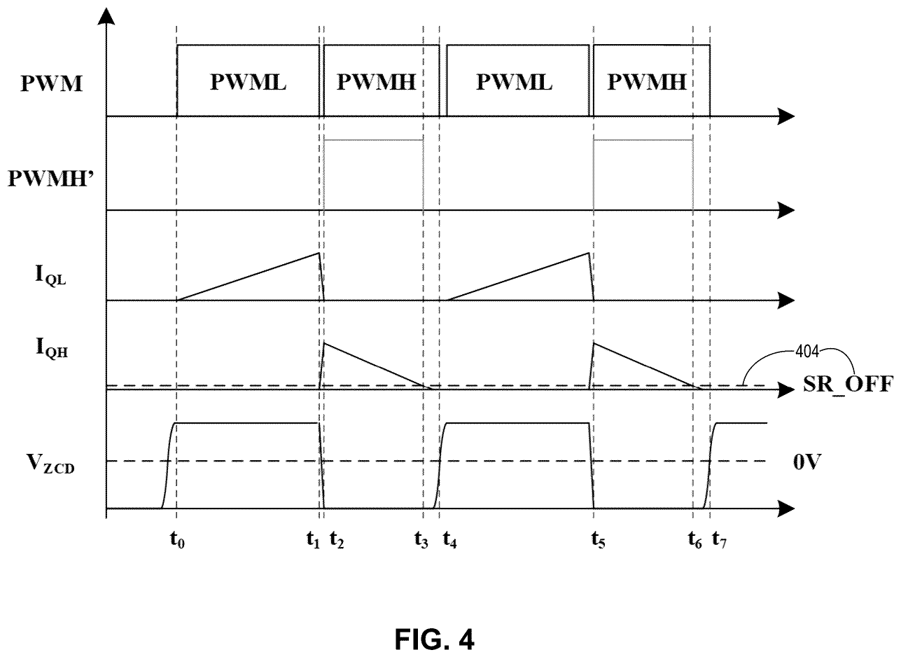

FIG. 4 illustrates graphs of operation waveforms at various nodes in PFC circuit of FIG. 1 where switch 102 (Q_{H}) operates as synchronous rectifier (SR) switch, according to some embodiments. FIG. 4 shows the waveforms at various nodes in the PFC circuit 100 when switch 102 (Q_{H}) works as the SR switch. When Q_{H} works in SR mode, the controller 106 can be arranged to control turning-on of the power switch 108, while the SR circuit 144 can control turning off the power switch 108. In this mode, switch 104 (Q_{L}) can operate as the main switch. At t₁, the main switch Q_{L} is transitioned to off state. After a predetermined dead time, the controller 106 can transmit PWMH signal. The PWMH high signal can transition Q_{H} to on-state (as SR) at t₂. During the inductor 128 demagnetizing phase, the Q_{H} current I_{QH} may decrease.

When I_{QH} reaches SR_OFF threshold 404, the SR controller circuit turns off Q_{H} by pulling down the PWMH′ signal to an internal reference ground at t₃. In some embodiments, the internal reference ground can be the switch node. The external PWMH signal can stay high because the controller 106 may not sense the I_{QH} current directly. Once Q_{H} is turned off, and after I_{QH} reaches zero, the resonance between the inductor 128 and power switch parasitic junction capacitance may occur. The zero-crossing of the current in auxiliary winding can occur at t₄. With PWMH high and zero-crossing occurring at the same time, controller 106 can determine that the demagnetizing phase is over and can cause pulling down of the PWMH. After a predetermined dead time, the controller 106 may start another switching cycle by turning on the PWML.

In some embodiments, combination of the circuits and methods disclosed herein can be utilized to provide circuits and methods for efficient operation of critical and discontinuous conduction mode totem-pole power factor correction (PFC) circuits. Although circuits and methods are described and illustrated herein with respect to several particular configuration of an PFC circuit, embodiments of the disclosure are suitable for use with other power converter topologies such as, but not limited to, AHB converter circuits and active clamp flyback (ACF) converters

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “and/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A power factor correction (PFC) circuit, comprising:
a first switch having a first power switch, a first current sense circuit and a first overcurrent protection circuit;
a second switch having a second power switch, a second current sense circuit and a second overcurrent protection circuit, the first switch coupled to the second switch at a switch node;
an inductor coupled between the switch node and an AC input terminal; and
a controller arranged to transmit control signals to the first and second switches;
wherein:
the first current sense circuit is arranged to transmit a first signal including at least one of a magnitude and a polarity of a first current through the first power switch; and
the first overcurrent protection circuit is arranged to receive the first signal and transition the first power switch to a first off-state in response to the first signal exceeding a first predetermined threshold.

2. The PFC circuit of claim 1, wherein the second current sense circuit is arranged to transmit a second signal including at least one of a magnitude and a polarity of a second current through the second power switch.

3. The PFC circuit of claim 2, wherein the second overcurrent protection circuit is arranged to receive the second signal and transition the second power switch to a second off-state in response to the second signal exceeding a second predetermined threshold.

4. The PFC circuit of claim 2, wherein the first switch further comprises a first driver circuit arranged to transmit first control signals to the first power switch based at least in part on the first signal and the control signals.

5. The PFC circuit of claim 2, wherein the second switch further comprises a second driver circuit arranged to transmit second control signals to the second power switch based at least in part on the second signal and the control signals.

6. The PFC circuit of claim 4, wherein the first switch further comprises a first synchronous rectification (SR) mode detection circuit that is arranged to generate a first SR signal in response to receiving the first signal.

7. The PFC circuit of claim 6, wherein the first driver circuit is further arranged to transmit the first control signals to the first power switch based at least in part on the first SR signal.

8. The PFC circuit of claim 2, wherein the second switch further comprises a second synchronous rectification (SR) mode detection circuit that is arranged to generate a second SR signal in response to receiving the second signal.

9. A method operating a power factor correction (PFC) circuit, the method comprising:
providing a first switch having a first power switch, a first current sense circuit and a first overcurrent protection circuit;
providing a second switch having a second power switch, a second current sense circuit and a second overcurrent protection circuit, the first switch coupled to the second switch at a switch node;
providing an inductor coupled between the switch node and an AC input terminal; and
providing a controller arranged to transmit control signals to the first and second switches;
transmitting a first signal, by the first current sense circuit, including at least one of a magnitude and a polarity of a first current through the first power switch; and
receiving the first signal, by the first overcurrent protection circuit; and
transitioning the first power switch to a first off-state in response to the first signal exceeding a first predetermined threshold.

10. The method of claim 9, further comprising transmitting a second signal, by the second current sense circuit, including at least one of a magnitude and a polarity of a second current through the second power switch.

11. The method of claim 10, further comprising receiving the second signal, by the second overcurrent protection circuit, and transitioning the second power switch to a second off-state in response to the second signal exceeding a second predetermined threshold.

12. The method of claim 10, further comprising transmitting first control signals, by a first driver circuit, to the first power switch based at least in part on the first signal and the control signals.

13. The method of claim 10, further comprising transmitting second control signals, by a second driver circuit, to the second power switch based at least in part on the second signal and the control signals.

14. The method of claim 12, further comprising generating a first SR signal, by a first synchronous rectification (SR) mode detection circuit, in response to receiving the first signal.

15. The method of claim 14, further comprising transmitting the first control signals, by the first driver circuit, to the first power switch based at least in part on the first SR signal.

16. The method of claim 14, further comprising generating a second SR signal, by a second synchronous rectification (SR) mode detection circuit, in response to receiving the second signal.

17. A circuit comprising:
a first switch having a first power switch, a first current sense circuit and a first overcurrent protection circuit;
a second switch having a second power switch, a second current sense circuit and a second overcurrent protection circuit, the first switch coupled to the second switch at a switch node;
an inductor coupled between the switch node and an AC input terminal; and
wherein the first current sense circuit is arranged to transmit a first signal including at least one of a magnitude and a polarity of a first current through the first power switch; and wherein the first overcurrent protection circuit is arranged to receive the first signal and transition the first power switch to a first off-state in response to the first signal exceeding a first predetermined threshold.

18. The circuit of claim 17, wherein the second current sense circuit is arranged to transmit a second signal including at least one of a magnitude and a polarity of a second current through the second power switch.

19. The circuit of claim 18, wherein the second overcurrent protection circuit is arranged to receive the second signal and transition the second power switch to a second off-state in response to the second signal exceeding a second predetermined threshold.

20. The circuit of claim 17, wherein the first power switch is a gallium nitride (GaN)-based switch.
